(19) United States
(12) Patent Application Publication
(10) Pub. No.: US 2022/0334286 A1
(43) Pub. Date: Oct. 20, 2022

(54) DETERMINING A LOCATION OF A TOOL IN A TUBULAR

(71) Applicant: Saudi Arabian Oil Company, Dhahran (SA)

(72) Inventors: Huseyin Rahmi Seren, Houston, TX (US); Max Deffenbaugh, Fulshear, TX (US)

(21) Appl. No.: 17/234,555

(22) Filed: Apr. 19, 2021

(51) Int. Cl. G01V 3/08; E21B 47/092

(52) U.S. Cl. CPC G01V 3/081; E21B 47/092

(57) ABSTRACT

Techniques for operating a tool include moving a tool in a magnetized tubular member that generates a stationary magnetic field. The tool includes a housing that defines an interior volume, a first magnetic field sensor positioned on or within the housing at a first location, and a second magnetic field sensor positioned on or within the housing at a second location apart from the first location by a separation distance. The techniques further include detecting a first magnetic field amplitude distribution sensed by the first magnetic field sensor started at a first time instant; detecting a second magnetic field amplitude distribution sensed by the second magnetic field sensor started at a second time instant; determining a time difference between the first and second time instants based on the identified magnetic field amplitudes; and determining a speed of the tool based on the separation distance and the time difference.

### TECHNICAL FIELD

The present disclosure describes apparatus, systems, and methods for determining a location of a tool in a tubular.

### BACKGROUND

Determining an orientation, speed, and position of a tool in a tubular is challenging. In the case of downhole tubulars in wellbores, wireline downhole tools typically use a wire length (for example, between a surface and the tool at depth) as reference for the tool's position. Spooling rate of the wireline is related to the tool's speed. As the cable length becomes longer, relating position and velocity of the tool to length and spooling of the wire becomes more difficult. Emerging as an alternative to wireline tools, untethered tools do not have any well-known method to estimate location and velocity. The same problem exists also for surface pipelines through which tools (for example, “pigs” are run). Pigs can be used to inspect and clean pipelines. Steel pipelines, however, block electromagnetic radiation, and thus, positioning technologies cannot be used.

### SUMMARY

In an example implementation, a measurement tool system includes a tool and a controller. The tool includes a housing configured to fit within and run into a magnetized tubular member, the housing defining an interior volume; a first magnetic field sensor positioned on or within the housing at a first location; and a second magnetic field sensor positioned on or within the housing at a second location apart from the first location by a separation distance. Each of the first and second magnetic field sensors is configured to detect a magnetic field amplitude value of a stationary magnetic field generated by the magnetized tubular member. The controller is configured to perform operations including identifying a first magnetic field amplitude distribution sensed by the first magnetic field sensor started at a first time instant; identifying a second magnetic field amplitude distribution sensed by the second magnetic field sensor started at a second time instant; determining a time difference between the first and second time instants based on the identified first and second magnetic field amplitudes; and determining a speed of the housing based on the separation distance and the time difference.

In an aspect combinable with the example implementation, at least one of the first or second magnetic field sensors includes a magnetoresistance or hall-effect sensor.

In another aspect combinable with any of the previous aspects, the magnetized tubular member includes a wellbore casing or a hydrocarbon system pipeline.

In another aspect combinable with any of the previous aspects, the controller is configured to perform operations further including determining, based on the speed of the housing, a location of the housing within the magnetized tubular member.

In another aspect combinable with any of the previous aspects, determining, based on the speed of the housing, a location of the housing within the magnetized tubular member includes determining a displacement of the housing by integrating the speed over the time difference; and determining the location based on the determined displacement and a known location of the housing at the first time instant.

In another aspect combinable with any of the previous aspects, the separation distance is based on a reference distance for a change to the magnetic field amplitude value of the stationary magnetic field at least above a noise level of the stationary magnetic field.

In another aspect combinable with any of the previous aspects, the separation distance is less than or equal to the reference distance.

In another aspect combinable with any of the previous aspects, the separation distance is greater than the reference distance.

In another aspect combinable with any of the previous aspects, determining the time difference between the first and second time instants based on the identified first and second magnetic field amplitudes includes (i) determining a time window for the first magnetic field sensor that begins at the first time instant, the time window including a plurality of first magnetic field amplitudes sensed by the first magnetic field sensor; (ii) determining a first time window for the second magnetic field sensor of the same duration as the time window for the first magnetic field sensor, the first time window including a plurality of second magnetic field amplitudes sensed by the second magnetic field sensor; (iii) determining an absolute value of each difference between corresponding first magnetic field amplitudes in the time window for the first magnetic field sensor and second magnetic field amplitudes in the first time window of the second magnetic field sensor; (iv) determining a sum of the absolute values to determine a metric of dissimilarity; (v) shifting the first time window for the second magnetic field sensor by a time shift to generate a next time window for the second magnetic field sensor; (vi) based on the shifting, iterating operations (iii)-(v) for a specified number of iterations to determine a plurality of metrics of dissimilarity; (vii) determining a minimum metric of dissimilarity of the plurality of metrics of dissimilarity; and (viii) identifying a time instant associated with the minimum metric of dissimilarity, the identified time instant including the second time instant.

In another aspect combinable with any of the previous aspects, the time window is based on an expected speed of the housing and the separation distance.

In another aspect combinable with any of the previous aspects, the controller is configured to perform operations further including processing the plurality of first magnetic field amplitudes sensed by the first magnetic field sensor in the time window between (i) and (iii); and processing the plurality of second magnetic field amplitudes sensed by the second magnetic field sensor in the first time window between (ii) and (iii).

In another aspect combinable with any of the previous aspects, the processing includes at least one of subtracting a mean value of the plurality of first magnetic field amplitudes from each of the plurality of first magnetic field amplitudes, and subtracting a mean value of the plurality of second magnetic field amplitudes from each of the plurality of second magnetic field amplitudes; or normalizing the plurality of first magnetic field amplitudes and the plurality of second magnetic field amplitudes.

In another example implementation, a method for operating a tool includes moving a tool in a magnetized tubular member that generates a stationary magnetic field. The tool includes a housing that defines an interior volume, a first magnetic field sensor positioned on or within the housing at a first location, and a second magnetic field sensor positioned on or within the housing at a second location apart from the first location by a separation distance. The method includes detecting a first magnetic field amplitude distribution sensed by the first magnetic field sensor started at a first time instant; detecting a second magnetic field amplitude distribution sensed by the second magnetic field sensor started at a second time instant; determining a time difference between the first and second time instants based on the identified first and second magnetic field amplitudes; and determining a speed of the tool moving in the magnetized tubular member based on the separation distance and the time difference.

In an aspect combinable with the example implementation, at least one of the first or second magnetic field sensors includes a magnetoresistance or hall-effect sensor.

In another aspect combinable with any of the previous aspects, the magnetized tubular member includes a wellbore casing or a hydrocarbon system pipeline.

Another aspect combinable with any of the previous aspects further includes determining, based on the speed of the tool, a location of the tool within the magnetized tubular member.

In another aspect combinable with any of the previous aspects, determining, based on the speed of the tool, a location of the tool within the magnetized tubular member includes determining a displacement of the tool by integrating the speed over the time difference; and determining the location based on the determined displacement and a known location of the tool at the first time instant.

In another aspect combinable with any of the previous aspects, the separation distance is based on a reference distance for a change to the magnetic field amplitude value of the stationary magnetic field at least above a noise level of the stationary magnetic field.

In another aspect combinable with any of the previous aspects, the separation distance is less than or equal to the reference distance.

In another aspect combinable with any of the previous aspects, the separation distance is greater than the reference distance.

In another aspect combinable with any of the previous aspects, determining the time difference between the first and second time instants based on the identified first and second magnetic field amplitudes includes (i) determining a time window for the first magnetic field sensor that begins at the first time instant, the time window including a plurality of first magnetic field amplitudes sensed by the first magnetic field sensor; (ii) determining a first time window for the second magnetic field sensor of the same duration as the time window for the first magnetic field sensor, the first time window including a plurality of second magnetic field amplitudes sensed by the second magnetic field sensor; (iii) determining an absolute value of each difference between corresponding first magnetic field amplitudes in the time window for the first magnetic field sensor and second magnetic field amplitudes in the first time window of the second magnetic field sensor; (iv) determining a sum of the absolute values to determine a metric of dissimilarity; (v) shifting the first time window for the second magnetic field sensor by a time shift to generate a next time window for the second magnetic field sensor; (vi) based on the shifting, iterating operations (iii)-(v) for a specified number of iterations to determine a plurality of metrics of dissimilarity; (vii) determining a minimum metric of dissimilarity of the plurality of metrics of dissimilarity; and (viii) identifying a time instant associated with the minimum metric of dissimilarity, the identified time instant including the second time instant.

In another aspect combinable with any of the previous aspects, the time window is based on an expected speed of the tool and the separation distance.

Another aspect combinable with any of the previous aspects further includes processing the plurality of first magnetic field amplitudes sensed by the first magnetic field sensor in the time window between (i) and (iii); and processing the plurality of second magnetic field amplitudes sensed by the second magnetic field sensor in the first time window between (ii) and (iii).

In another aspect combinable with any of the previous aspects, the processing includes at least one of subtracting a mean value of the plurality of first magnetic field amplitudes from each of the plurality of first magnetic field amplitudes, and subtracting a mean value of the plurality of second magnetic field amplitudes from each of the plurality of second magnetic field amplitudes; or normalizing the plurality of first magnetic field amplitudes and the plurality of second magnetic field amplitudes.

In another example implementation, a measurement tool includes a housing configured to fit within and run into a magnetized tubular member, where the housing defines an interior volume; a plurality of magnetic field sensors positioned on or within the housing, where each of the plurality of magnetic field sensors is configured to detect a magnetic field amplitude value of a stationary magnetic field generated by the magnetized tubular member, and each pair of adjacent magnetic field sensors is separated by a preset separation distance; and a controller positioned in the interior volume or on the housing. The controller is configured to perform operations including identifying a plurality of first magnetic field amplitudes sensed by the plurality of magnetic field sensors at a first time instant; identifying a plurality of second magnetic field amplitudes sensed by the plurality of magnetic field sensors at a second time instant subsequent to the first time instant; correlating the plurality of second magnetic field amplitudes sensed by the plurality of magnetic field sensors at the second time instant with the plurality of first magnetic field amplitudes sensed by the plurality of magnetic field sensors at the first time instant; and determining, based on the correlation, a distance between the housing at a first location in the magnetized tubular member at the first time instant and the housing at a second location in the magnetized tubular member at the second time instant.

In an aspect combinable with the example implementation, the controller is configured to perform operations further including determining a speed of the housing based on the distance and a difference between the second time instant and the first time instant.

In another aspect combinable with any of the previous aspects, the plurality of magnetic field sensors includes at least ten magnetic field sensors.

In another aspect combinable with any of the previous aspects, identifying the first plurality of magnetic field amplitudes sensed by the plurality of magnetic field sensors at the first time instant includes identifying one of the first plurality of magnetic field amplitudes that is sensed for each of the plurality of magnetic field sensors at the first time instant.

In another aspect combinable with any of the previous aspects, the magnetized tubular member includes a wellbore casing or a hydrocarbon system pipeline.

In another aspect combinable with any of the previous aspects, correlating the plurality of second magnetic field amplitudes sensed by the plurality of magnetic field sensors at the second time instant with the plurality of first magnetic field amplitudes sensed by the plurality of magnetic field sensors at the first time instant includes (i) determining, for each of the plurality of magnetic field sensors, an absolute value of a difference between the second magnetic field amplitude and the first magnetic field amplitude; and (ii) determining a sum of the absolute values to determine a metric of dissimilarity.

In another aspect combinable with any of the previous aspects, the controller is configured to perform operations further including (iii) identifying a plurality of next magnetic field amplitudes sensed by the plurality of magnetic field sensors at a next time instant subsequent to the second time instant; (iv) determining, for each of the plurality of magnetic field sensors, a next absolute value of a difference between the next magnetic field amplitude and the first magnetic field amplitude; and (v) determining a next sum of the next absolute values to determine a next metric of dissimilarity.

In another aspect combinable with any of the previous aspects, the controller is configured to perform operations further including (vi) iterating operations (iii)-(v) for a specified number of iterations to determine a plurality of metrics of dissimilarity; (vii) determining a minimum metric of dissimilarity of the plurality of metrics of dissimilarity; (viii) identifying a distance associated with the minimum metric of dissimilarity; and (ix) determining a new location of the housing at the next time instant based on the identified distance associated with the minimum metric of dissimilarity and previously known location at the first time instant

In another aspect combinable with any of the previous aspects, the controller is configured to perform operations further including determining speed of the housing based on the identified distance associated with the minimum metric of dissimilarity and a difference between the next time instant and the first time instant.

Implementations of a tool for operating in a tubular according to the present disclosure may include one or more of the following features. For example, a tool can accurately determine a speed and location (or displacement) of the tool within a tubular during movement within the tubular. As another example, a tool can utilize a stationary magnetic field produced or generated by the tubular (for example, a steel tubular) to determine speed and location (or displacement). As another example, a tool can determine a speed within a tubular that varies with time or distance traveled, as well as a constant or substantially constant speed within the tubular.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1B are schematic diagrams of a tool location system for a tubular according to the present disclosure.

FIGS. 2A-2C are schematic illustrations of example implementations of a tool moving in a tubular according to the present disclosure.

FIGS. 3A-3B are flowcharts that illustrate example processes for determining a speed, location, or both, of a tool in a tubular according to the present disclosure.

FIGS. 4A-4I are graphs that describe magnetic field amplitude values over time, frequency, or distance according to the present disclosure.

FIG. 5 shows a graph that describes windowed magnetic field amplitude values over time according to the present disclosure.

FIG. 6 shows a graph that describes magnetic field amplitude value dissimilarity metrics over a time shift according to the present disclosure.

FIGS. 7A-7B are graphs that describe magnetic field amplitude values over time, frequency, or distance according to the present disclosure.

FIGS. 7C-7D are flowcharts that illustrate example processes for determining a speed, location, or both, of a tool in a tubular according to the present disclosure.

FIG. 8 is a schematic illustration of an example controller (or control system) for determining a location, speed, or both, of a tool in a tubular according to the present disclosure.

### DETAILED DESCRIPTION

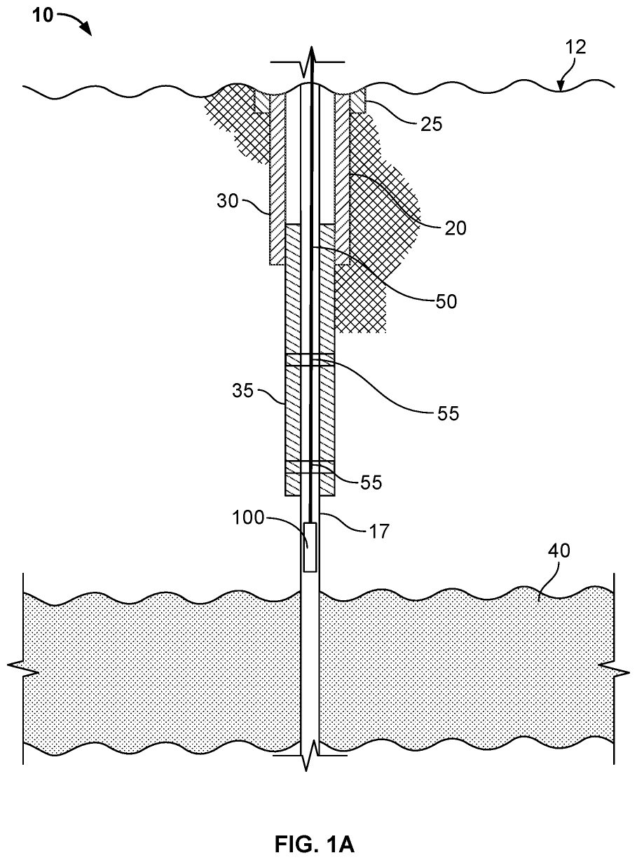

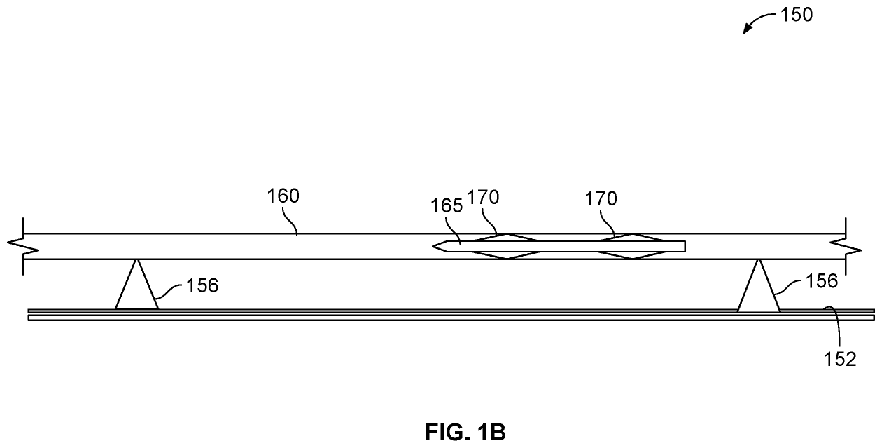

FIG. 1A is a schematic diagram of wellbore system 10 that includes a downhole tool 100 according to the present disclosure. Generally, FIG. 1A illustrates a portion of one embodiment of a wellbore system 10 according to the present disclosure in which the downhole tool 100 may be run into a wellbore 20 and activated during the run in (or run out) process or when the tool 100 reaches a particular location of a wellbore tubular 17 (or simply, tubular 17) within the wellbore 20. In this example, the downhole tool 100 is coupled to a downhole conveyance 50, such as a wireline or other conveyance that, in some aspects, may facilitate the transmission of information to and from the downhole tool 100 while in the wellbore 20. In alternative aspects, the downhole tool 100 may be untethered in that, during the running in process, the running out process, or during any operations of the downhole tool 100 in the wellbore 20, the downhole tool 100 is disconnected, decoupled, or otherwise unattached from a downhole conveyance, such as a tubular (tubular work string or coiled tubing) or wireline or other conductor. In some aspects, an untethered downhole tool may be conveyed into the wellbore 20, or out of the wellbore 20 by, for instance, a fluid circulated within the wellbore tubular 17 or within the wellbore 20, either alone or in combination with other forces on the untethered downhole tool 100 (for example, gravitational forces, buoyant forces, hydrodynamic forces, or a combination thereof).

Although not illustrated in FIG. 1A, the downhole tool 100 may include a centralizer or decentralizer that, during the running in and/or running out process, keeps the downhole tool 100 aligned at a particular axis relative to, for example, a vertical axis of the wellbore tubular 17. In some aspects, the downhole tool 100, as an untethered tool, comprises a relatively lightweight miniaturized tool (for example, a tool with a length several times smaller than the wellbore diameter). For such tools, there are not many limiting factors for the alignment within a wellbore; thus all the degrees of freedoms are available. Conventional centralizers and decentralizers that are used for wireline tools may not be suitable for such miniaturized untethered tools since they increase the chance of jamming in the wellbore. In some aspects, the downhole tool 100 can serve various purposes, such as collecting physical or chemical information regarding the downhole fluids or the formation rocks of the wellbore system 10.

As shown, the wellbore system 10 accesses a subterranean formation 40 and provides access to hydrocarbons located in such subterranean formation 40. In an example implementation of system 10, the system 10 may be used for a production operation in which the hydrocarbons may be produced from the subterranean formation 40 within the wellbore tubular 17 (for example, as a production tubing or casing). However, tubular 17 may represent any tubular member positioned in the wellbore 20 such as, for example, coiled tubing, any type of casing, a liner or lining, another downhole tool connected to a work string (in other words, multiple tubulars threaded together), or other form of tubular member.

A drilling assembly (not shown) may be used to form the wellbore 20 extending from the terranean surface 12 and through one or more geological formations in the Earth. One or more subterranean formations, such as subterranean zone 40, are located under the terranean surface 12. As will be explained in more detail below, one or more wellbore casings, such as a surface casing 30 and intermediate casing 35, may be installed in at least a portion of the wellbore 20. In some embodiments, a drilling assembly used to form the wellbore 20 may be deployed on a body of water rather than the terranean surface 12. For instance, in some embodiments, the terranean surface 12 may be an ocean, gulf, sea, or any other body of water under which hydrocarbon-bearing formations may be found. In short, reference to the terranean surface 12 includes both land and water surfaces and contemplates forming and developing one or more wellbore systems 10 from either or both locations.

In some embodiments of the wellbore system 10, the wellbore 20 may be cased with one or more casings. As illustrated, the wellbore 20 includes a conductor casing 25, which extends from the terranean surface 12 shortly into the Earth. A portion of the wellbore 20 enclosed by the conductor casing 25 may be a large diameter borehole. Additionally, in some embodiments, the wellbore 20 may be offset from vertical (for example, a slant wellbore). Even further, in some embodiments, the wellbore 20 may be a stepped wellbore, such that a portion is drilled vertically downward and then curved to a substantially horizontal wellbore portion. Additional substantially vertical and horizontal wellbore portions may be added according to, for example, the type of terranean surface 12, the depth of one or more target subterranean formations, the depth of one or more productive subterranean formations, or other criteria.

Downhole of the conductor casing 25 may be the surface casing 30. The surface casing 30 may enclose a slightly smaller borehole and protect the wellbore 20 from intrusion of, for example, freshwater aquifers located near the terranean surface 12. The wellbore 20 may than extend vertically downward. This portion of the wellbore 20 may be enclosed by the intermediate casing 35. Any of the illustrated casings, as well as other casings that may be present in the wellbore system 10, may include one or more casing collars 55 (as shown in FIG. 1A).

FIG. 1B shows an example pipeline system 150 in which a tool 165 according to the present disclosure may be used. In this example, the tool 165 may be a “pig” or pipeline tool for an above-surface (or below surface) hydrocarbon processing pipeline system, such as the system 150. Pigs, in some aspects, are used in pipeline systems to inspect characteristics of the pipelines by measuring properties of the material (for example, steel) from which the tubular members are made. As shown in this example, the tool 165 includes one or more centralizers 170 that maintain a centerline axis of the tool 165 aligned with a centerline axis of a tubular 160 while the tool 165 is moving through (or stationary in) the tubular 160. In this example, the pipeline system 150 is an above-ground system in which multiple tubulars 160 (coupled together, for example, threadingly) are mounted on supports 156 that are positioned on a support surface 152 (such as a terranean surface).

Tools according to the present disclosure, such as downhole tool 100 and pipeline tool 165, may include two or more magnetic field sensors that, as described in more detail herein, allow for the determination of a speed, displacement, or location (or a combination thereof) in the tubular in which they are located. As described herein, the two or more magnetic field sensors located in or on the downhole tool 100 and pipeline tool 165 can, independently, sense amplitude values of the static magnetic field while traveling through such tubulars. The sensed amplitude values can be used to determine a speed, displacement, or location (or a combination thereof) in the tubular in which the tools 100 and 165 are located. The use of two or more magnetic field sensors (for example, magnetometers such as magnetoresistance or hall effect-based sensors, or any other magnetic field sensor that can detect stationary magnetic fields) solves issues related to the accurate determination of speed, location, and displacement of tools in steel tubulars. For example, for a downhole tool, casing collar locators are widely used downhole sensors that detect joint locations between two neighboring pipes. Length of each pipe and their order in a wellbore is known and recorded in a well completion report. Based on the completion report, detected joints are counted and used as location reference for the downhole tools. However, casing collar locators do not provide information within a tubular. Therefore, the position of a tool within a tubular must rely on other sensors or be estimated.

Downhole wellbore tools may also use natural gamma counts to determine depth and thus location of a tool within a wellbore. Various rock layers produce gamma rays at varying intensities depending on the lithology. A gamma log can be mapped on a reference depth measurement and can be used as a depth reference for the upcoming operations (for example, logging). Typically, gamma ray tools can provide a vertical resolution of 12 inches, but require a large volume and power, which is not suitable for small and low power systems (such as untethered logging tools).

As another example, accelerometers and gyroscopes can be used to track changes in a motion of a tool in a tubular. However, as the output integral is calculated to find velocity, position, and rotation, error quickly accumulates and results in inaccurate measurements. Moreover, it is not possible to predict if a tool is stationary or moving at a constant speed based on the acceleration data. Regarding surface pipelines, the same issues exist as described for downhole tools. Further, as steel tubulars block electromagnetic radiation, positioning technologies cannot be used with pigs.

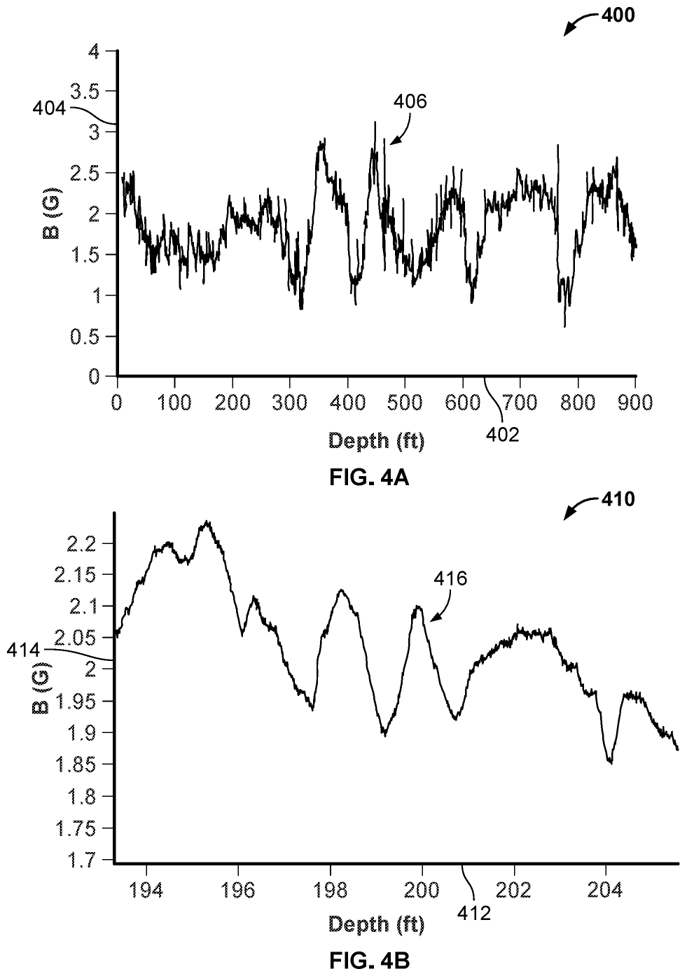

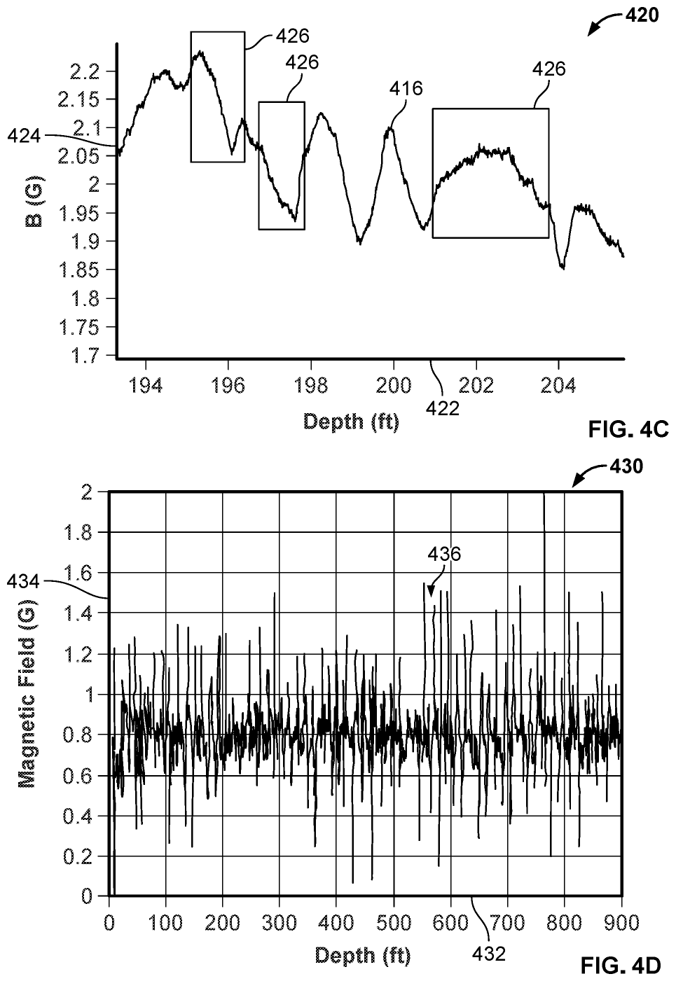

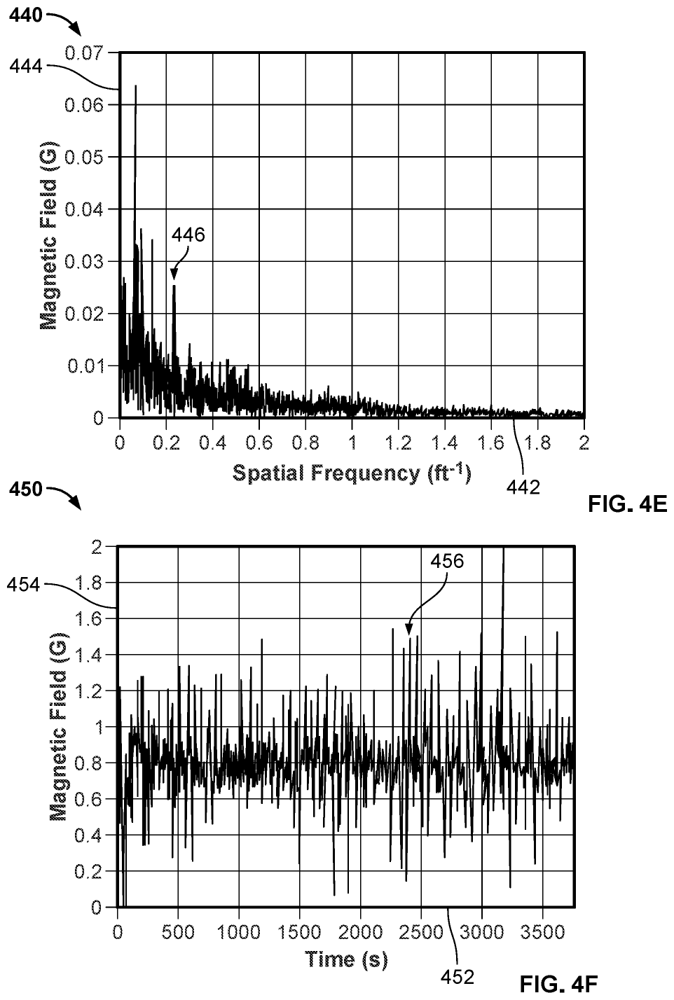

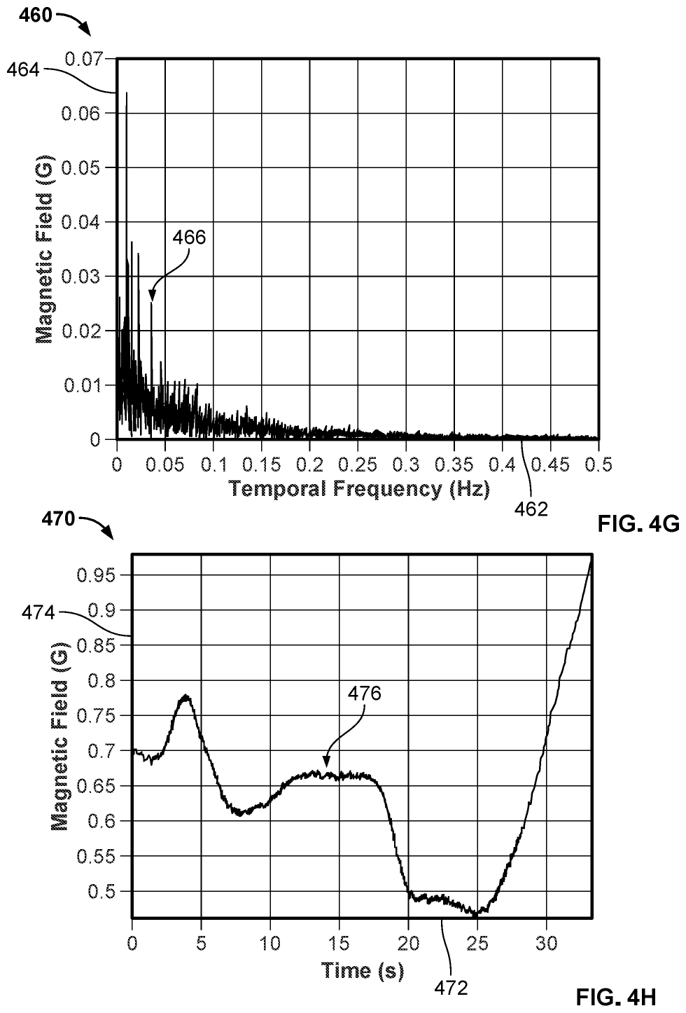

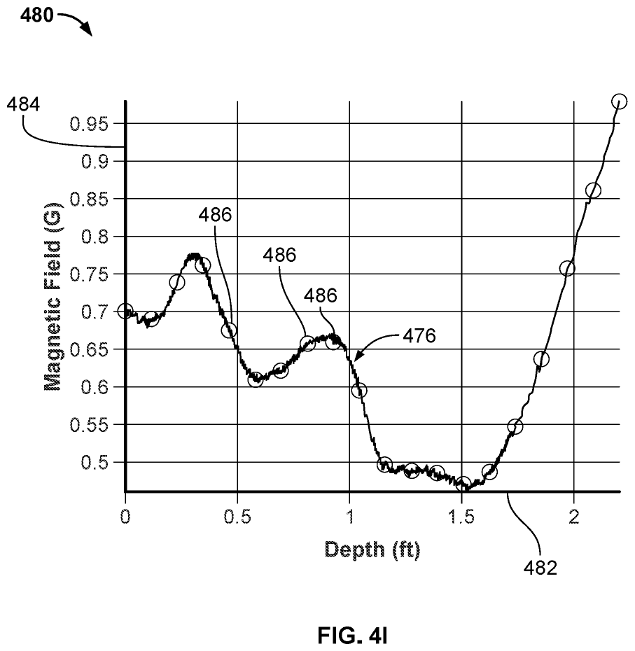

As noted, steel tubulars exhibit (or generate) a static magnetic field (for example, due to the manufacturing process of such tubulars). The static magnetic field can be sensed (by the two or more magnetic field sensors of a tool according to the present disclosure) and recorded. For example, turning to FIG. 4A, this figure illustrates a graph 400 that shows magnetic field amplitude relative to depth in a wellbore that includes a steel tubular (such as tubular 17). As shown, the graph 400 includes an x-axis 402 that represents wellbore depth (in feet) and a y-axis 404 that represents magnetic field amplitude, B (in Gauss, G). A curve 406 represents the magnetic field amplitude of the static magnetic field produced by the steel tubular sensed at depth from 0 feet below a terranean surface to 900 feet below the terranean surface. Another example of such a curve is shown in FIG. 4B, which illustrates a graph 410 that shows magnetic field amplitude relative to an approximately 10 foot portion of a wellbore that includes a steel tubular (such as tubular 17). As shown, the graph 410 includes an x-axis 412 that represents wellbore depth (in feet) and a y-axis 414 that represents magnetic field amplitude, B (in G). A curve 416 represents the magnetic field amplitude of the static magnetic field produced by the steel tubular sensed at a portion of depth from about 194 feet below a terranean surface to about 204 feet below the terranean surface.

As shown by curve 416, within a discrete portion of a downhole steel tubular (or surface steel pipeline), the sensed magnetic field amplitude varies and includes recognizable peaks and valleys. Such recognizable portions of the curve 416 may be identified as “features” or “windows” (that will be described in more detail later). For example, FIG. 4C illustrates a graph 420 that is the same as graph 410 but with identified windows. As shown, graph 420 includes an x-axis 422 that represents wellbore depth (in feet) and a y-axis 424 that represents magnetic field amplitude, B (in G). The curve 416 represents the magnetic field amplitude of the static magnetic field produced by the steel tubular sensed at a portion of depth from about 194 feet below a terranean surface to about 204 feet below the terranean surface, the same as curve 416. Here, identified windows 426 each represent a portion of the curve 416 over a particular distance (or a particular time) that is an identifiable feature. A “feature,” according to example implementations of the present disclosure, can be a signal (magnetic amplitude) segment (a portion of the curve 416, for instance) with the smallest length that is differentiable from adjacent segments, or recognizable, due to its shape, so that it can be used as a landmark. In some example, in order to have a “feature,” the magnetic amplitude must change at least above a noise level, (and in some aspects, well above the noise level) and should be varying.

The “feature size” refers to the length of the window (in distance or time) that makes it differentiable from adjacent portions of the signal curve. The feature sizes of the windows 426 in FIG. 4C are in the range of 1-2 feet. In some aspects, feature size can be variable. In some aspects, while there is no strict formula to define a feature size, the smaller the selected windows 426 get, the harder it may be to recognize the signal in the curve. For instance, if a window size is selected that is much smaller than a “feature size,” a global minimum may not be found when a dissimilarity metric (as described later) is determined.

As seen in the FIG. 4C, there may be a variation in the feature size, so there is a distribution of sizes of windows 126. In example aspects, measurement of this distribution can include a determination of a frequency content of the magnetic amplitude signal by taking its Fourier transform. This can provide a spectrum (in other words, a distribution of feature sizes with respect to spatial frequency, ft¹). In some aspects, a minimum limit to the window size can be selected based on such a spectrum. For instance, FIG. 4D shows a graph 430 of a magnetic field amplitude curve 436 for an initial 900 feet of a steel tubular in a wellbore (with x-axis 432 of depth in feet and y-axis 434 of magnetic field amplitude, B, Gauss). FIG. 4E is a graph 440 that illustrates a Fourier transform (or spectrum) 446 of the curve 436 shown in FIG. 4D. Graph 440 includes an x-axis 442 that represents spatial frequency (in ft⁻¹) and a y-axis 444 of magnetic field amplitude, B (in G). Based on the spectrum 446, it can be determined that most features have a variation rate between 0.01 and 1 ft⁻¹, or a size of 100 feet and 1 foot, respectively. Therefore, the minimum window size can be set at around 1 foot. As described later, in example implementations, window size can be used, along with the sensed magnetic field amplitudes of the two or more magnetic field sensors and separation distance between the two or more sensors, to determine a tool's speed, location, or displacement (or a combination thereof).

Such a spectrum analysis can be applied over a distance (as described) or over a time. For example, in some aspects, the tool moving, for example, downhole in a wellbore steel tubular has a depth reference (for example, a logging tool or casing collar locator). In such cases, the spectrum analysis can be applied over a distance as described. But in examples in which the tool moving through the steel tubular has no depth reference, the spectrum analysis can be applied over time. For example, in a time spectrum analysis, magnetic field amplitude measurements are acquired (for example, by the two or more magnetic field sensors of the tool) with respect to time, where the scale of the time axis may depend on the tool speed. The spectrum analysis that is described with reference to FIGS. 4D-4E can be reapplied to a time referenced signal.

For instance, FIG. 4F shows a graph 450 of magnetic field amplitude values over time; here, the magnetic field amplitude values are identical to those of curve 436 in FIG. 4D but with reference to time, with a tool speed of 0.25 ft./s. As shown, FIG. 4F shows a magnetic field amplitude curve 456 for a tool travel time of more than 3500 seconds (with x-axis 452 of time in seconds and y-axis 454 of magnetic field amplitude, B, Gauss). FIG. 4G is a graph 460 that illustrates a Fourier transform (or spectrum) 466 of the curve 456 shown in FIG. 4F. Graph 460 includes an x-axis 462 that represents temporal frequency (in Hz) and a y-axis 464 of magnetic field amplitude, B (in G). Based on the spectrum 466, temporal feature sizes, and thus, time windows, can be selected. In this example, most of the spectrum 466 is below 0.2 Hz; therefore the time window length may not be smaller than 5 seconds (time as inverse of Hz).

In some aspects, the time spectrum analysis can yield different time window lengths for different tool speeds; however, in many tool operations, the tool speed may not significantly change during tool job. Thus, an average time window length can be acquired. Alternatively, if the tool speed is expected to change significantly, the spectrum analysis can be continuously done (for example, by a controller on board the tool) during the movement of the tool inside the steel tubular, and the window length can be dynamically adjusted (for example, during movement of the tool in the steel tubular). As an example, a new spectrum can be calculated from the data (magnetic field amplitude values) collected in the last, for example, 1 minute, and the frequency content can be analyzed to limit the window length based on such data.

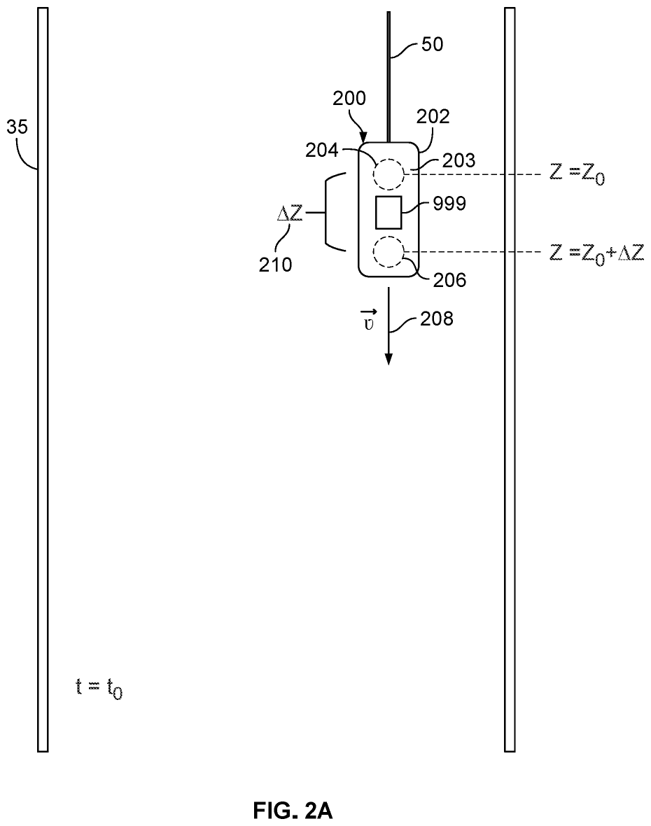

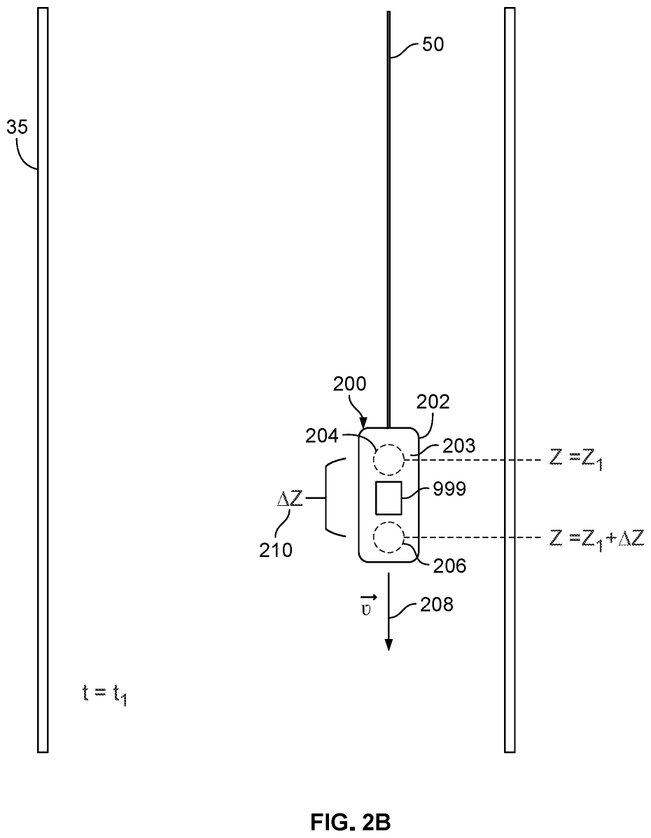

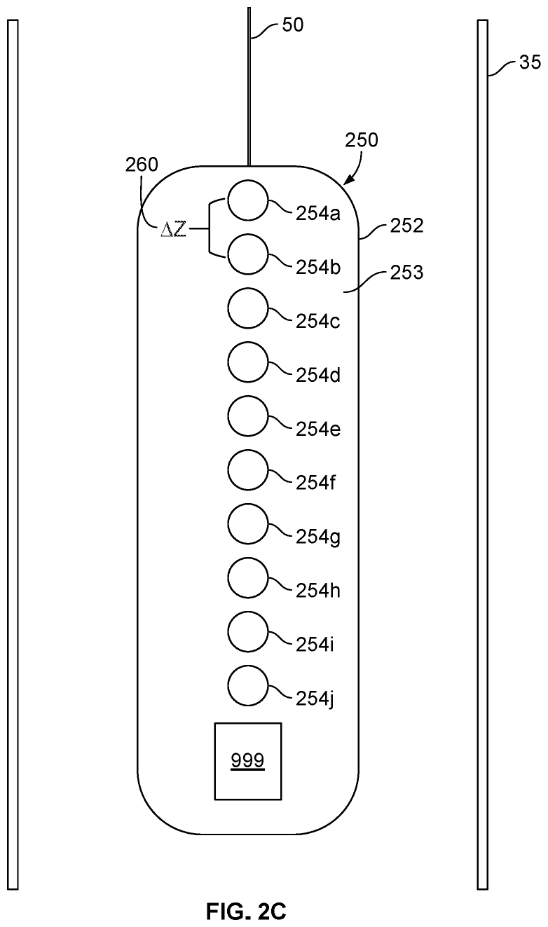

FIGS. 2A-2B are schematic illustrations of example implementations of a tool 200 moving in a tubular according to the present disclosure. Although in this example, the tool 200 represents a downhole tool coupled to the downhole conveyance 50 within wellbore tubular 17, tool 200 may also represent a surface pipeline tool (such as a pig) traveling in a surface steel tubular. Further, while tool 200 does not, as shown, include a centralizer or decentralizer, such components may be part of the tool 200 as well. Also, while shown as coupled to the conveyance 50, the tool 200 may be an untethered downhole (or surface) tool configured to run into and through a steel tubular (for example, by fluid circulation or otherwise).

The example implementation of the tool 200 in FIGS. 2A-2B includes a housing 202 that defines an internal volume 203 within the tool 200. In this example, two magnetic field sensors 204 and 206 are positioned within the housing 202 (in the volume 203); alternatively, the two magnetic field sensors 204 and 206 may be positioned on or attached to the housing 202. In this example, magnetic field sensor 206 can be considered a front, or downhole, magnetic field sensor, while magnetic field sensor 204 can be considered a back, or uphole, magnetic field sensor.

As shown in FIGS. 2A-2B, the magnetic field sensors 204 and 206 are separated in the housing 202 by a separation distance 210 (Δz). The separation distance 210 is a known, preset distance that, for example, can depend on the size of the tool 200 or other characteristics. In some aspects, the magnetic field sensors 204 and 206 are separated along an axis of tool movement; thus in FIGS. 2A-2B, the sensors 204 and 206 are separated in a vertical direction, as the tool 200 (as a downhole wellbore tool) is expected to travel (mainly) vertically within a wellbore. For a surface tool, sensors 204 and 206 are separated in a horizontal direction, as the tool 200 (as a surface pipeline tool) is expected to travel (mainly) horizontally within a pipeline. Thus, the separation distance 210 is also aligned with the preferred direction of motion of the tool 200.

The example implementation of the tool 200 also includes a controller 999. In some aspects, the controller 999 is a microprocessor-based controller that includes, for example, one or more hardware processors and one or more tangible memory modules that store instructions for the processors to execute. By executing such instructions, the controller 999 can perform operations according to the present disclosure for the tool 200 (including the magnetic field sensors 204 and 206).

As shown, FIG. 2A represents the tool 200 at a time, t₀, as the tool 200 moves through the wellbore tubular 17. At t₀, the back magnetic field sensor 204 is at a location (for example, depth in the wellbore tubular 17) of z₀, while the front magnetic field sensor 206 is at a location of z₀+Δz (the location of the back magnetic field sensor 204 plus the separation distance 210). The tool 200 is moving with a speed 208 in a downhole direction (in other words, with a velocity, v). As shown, FIG. 2B represents the tool 200 at a subsequent (to t₀) time, t₁, as the tool 200 further moves through the wellbore tubular 17. At t₁, the back magnetic field sensor 204 is at a location (for example, depth in the wellbore tubular 17) of z₁, while the front magnetic field sensor 206 is at a location of z₁+Δz (the location of the back magnetic field sensor 204 plus the separation distance 210). The tool 200 is still moving with a speed 208 in a downhole direction (in other words, with a velocity, v). At both times, to and t₁, and at time instants between such two times, the two magnetic field sensors 204 and 206 may be sensing magnetic field amplitudes generated by the stationary magnetic field of the wellbore tubular 17 (and, in some aspects, providing or exposing such sensed measurements relative to time to the controller 999).

FIG. 2C is a schematic illustrations of another example implementation of a tool 250 (that can move in a tubular) according to the present disclosure. Although in this example, the tool 250 represents a downhole tool coupled to the downhole conveyance 50 within wellbore tubular 17, tool 250 may also represent a surface pipeline tool (such as a pig) traveling in a surface steel tubular. Further, while tool 250 does not, as shown, include a centralizer or decentralizer, such components may be part of the tool 250 as well. Also, while shown as coupled to the conveyance 50, the tool 250 may be an untethered downhole (or surface) tool configured to run into and through a steel tubular (for example, by fluid circulation or otherwise).

The example implementation of the tool 250 in FIG. 2C includes a housing 252 that defines an internal volume 253 within the tool 250. In this example, more than two magnetic field sensors are positioned within the housing 252 (in the volume 253). For instance, the example implementation of the tool 250 includes ten magnetic field sensors 254a-254j; alternatively, other implementations of the tool 250 may include fewer magnetic field sensors (for example, between 3 and 10) or more magnetic field sensors (for example, more than 10).

As shown in FIG. 2C, each magnetic field sensor 254a-254j is separated from an adjacent neighbor magnetic field sensors by a separation distance 260 (Δz). The separation distance 260 is a known, preset distance that, for example, can depend on the size of the tool 200 or other characteristics. In some aspects, the magnetic field sensors 254a-254j are separated along an axis of tool movement; thus in FIG. 2C, the sensors 254a-254j are separated in a vertical direction, as the tool 250 (as a downhole wellbore tool) is expected to travel (mainly) vertically within a wellbore. For a surface tool, sensors 254a-254j are separated in a horizontal direction, as the tool 250 (as a surface pipeline tool) is expected to travel (mainly) horizontally within a pipeline. Thus, the separation distance 260 is also aligned with the preferred direction of motion of the tool 250.

The example implementation of the tool 250 also includes a controller 999. In some aspects, the controller 999 is a microprocessor-based controller that includes, for example, one or more hardware processors and one or more tangible memory modules that store instructions for the processors to execute. By executing such instructions, the controller 999 can perform operations according to the present disclosure for the tool 250 (including the magnetic field sensors 254a-254j).

Just as with tool 200, the tool 250 may move through a tubular. At a time, t₀, the magnetic field sensor 254a is at a location (for example, depth in the wellbore tubular 17) of z₀, while the magnetic field sensor 254b is at a location of z₀+Δz (the location of the magnetic field sensor 254a plus the separation distance 260), the magnetic field sensor 254c is at a location of z₀+2Δz (the location of the magnetic field sensor 254a plus twice the separation distance 260), and so on. The tool 250 can move with a particular speed through the steel tubular. At a subsequent (to t₀) time, t₁, the magnetic field sensor 254a is at a location (for example, depth in the wellbore tubular 17) of z₁, while the magnetic field sensor 254b is at a location of z₁+Δz (the location of the magnetic field sensor 254a plus the separation distance 260), the magnetic field sensor 254c is at a location of z₁+2Δz (the location of the magnetic field sensor 254a plus twice the separation distance 260), and so on. At both times, to and t₁, and at time instants between such two times, the ten magnetic field sensors 254a-254j may be sensing magnetic field amplitudes generated by the stationary magnetic field of the wellbore tubular 17 (and, in some aspects, providing or exposing such sensed measurements relative to time to the controller 999).

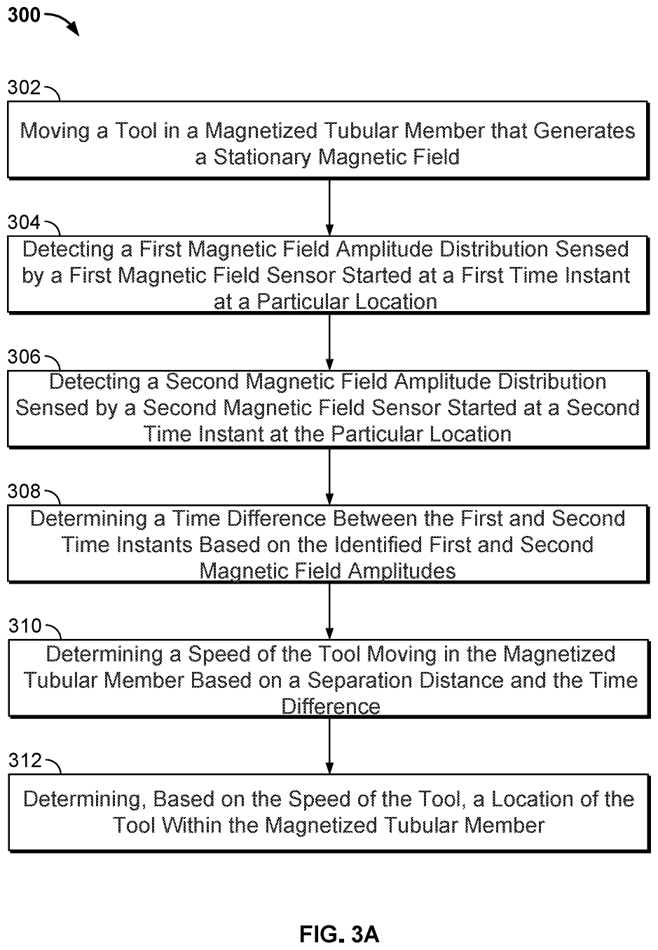

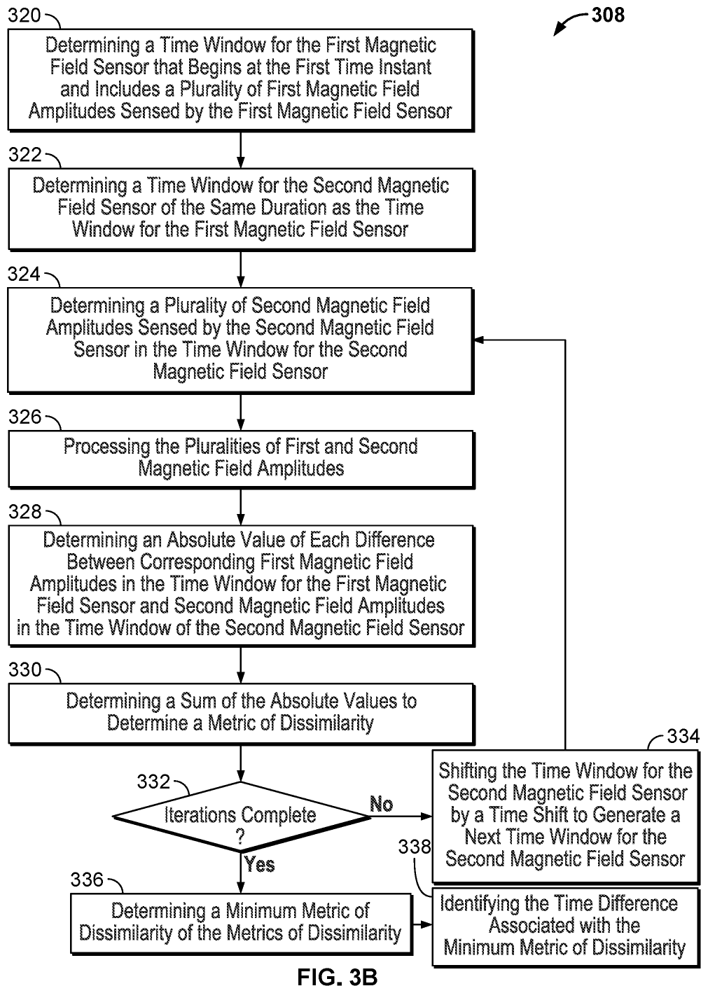

FIGS. 3A-3B are flowcharts that illustrate example methods for determining a speed, location, or both, of a tool in a tubular according to the present disclosure. For example, FIG. 3A illustrates method 300 for determining a speed, location, or both, of a tool in a tubular. In some aspects, method 300 may be performed with or by the example tool 200 shown in FIGS. 2A-2B, or with the example tool 250 shown in FIG. 2C. In some aspects, all or a portion of method 300 may be performed with the controller 999, either during a downhole operation of the tool 200 (or 250). Method 300 may begin at step 302, which includes moving a tool in a magnetized tubular member that generates a stationary magnetic field. For example, the tool 200 may be moved through steel wellbore tubular 17, or a surface tool 200 may be moved through the steel pipeline 160. In some aspect, the tool 200 is moved by a conveyance, such as a wireline 50 or other downhole conveyance, or in the case of a surface tool 200, a conductor or tractor. In some aspects, movement of the tool 200 through the magnetized steel tubular can be untethered movement, such as when the tool 200 is an untethered downhole tool that moves through the wellbore tubular 17 by, for example, a force of gravity, circulating fluid, or both. As described, the steel tubular may generate or include a stationary magnetic field due to the manufacturing process.

Method 300 may continue at step 304, which includes detecting a first magnetic field amplitude distribution sensed by a first magnetic field sensor started at a first time instant at a particular location. For example, as the tool 200 is moving through the steel tubular, a first magnetic field sensor (for example, sensor 206 on tool 200) detects magnetic field amplitudes, including at a first time instant (for example, t₀). In some aspects, a first magnetic field sensor of a tool can be the magnetic field sensor (of several sensors) that is positioned in the tool at a front (or downhole) end of the tool, i.e., toward a direction of movement of the tool. The first magnetic field sensor can detect magnetic field amplitudes continuously or periodically during movement of the tool through the steel tubular, with such magnitude values being recorded or identified by the controller 999.

Method 300 may continue at step 306, which includes detecting a second magnetic field amplitude distribution sensed by a second magnetic field sensor at the particular location (for example, the same location as the first sensor) and started at a second time instant. For example, as the tool 200 moves a distance that is equal to the length between the two sensors through the steel tubular, a second magnetic field sensor (for example, sensor 204 on tool 200) detects magnetic field amplitudes, including at a second time instant subsequent to the first time instant (for example, t₁). In some aspects, a second magnetic field sensor of a tool can be the magnetic field sensor (of several sensors) that is positioned in the tool at a rear (or uphole) end of the tool, i.e., away a direction of movement of the tool. The second magnetic field sensor can also be, in the case of tool 250 with ten sensors, adjacent the first magnetic field sensor (for example, with 254j being the first magnetic field sensor and 254i being the second magnetic field sensor). The second magnetic field sensor can detect magnetic field amplitudes continuously or periodically during movement of the tool through the steel tubular, with such magnitude values also being recorded or identified by the controller 999.

Method 300 may continue at step 308, which includes determining a time difference between the first and second time instants based on the identified first and second magnetic field amplitude distributions (or, for example, magnetic field patterns that correspond to the same location inside a magnetized tubular member). For example, in some aspects, the controller 999 may correlate the identified first and second magnetic field amplitudes, that constitutes a feature, to determine, for example, a minimum (or no) difference between the second magnetic field amplitudes (taken starting at time, t₁) and the first magnetic field amplitudes (taken starting at t₀). Such a determined minimal difference can indicate, for example, that the second magnetic field sensor passed a particular location within the steel tubular at the time, t₁, after the first magnetic field sensor passed the same particular location at the time, to (based on a measured magnetic field amplitude values at that particular location of the steel tubular). After determining such a minimal difference (or zero difference), the second time instant (t₁) can be determined by the controller 999 as the time instant when such minimal difference occurred. Thereafter, the controller 999 can determine the time difference between t₁ and to.

An example implementation of step 308 and the correlation between the identified first and second magnetic field amplitudes is shown in FIG. 3B, which shows an example sub-process for step 308. The sub-process of FIG. 3B can begin at step 320, which includes determining a time window for the first magnetic field sensor that begins at the first time instant and includes a plurality of first magnetic field amplitudes sensed by the first magnetic field sensor. For example, as previously described, a “window” can be a particular distance or time over which a feature is recognizable in a curve of values of magnetic field amplitude as measured by a particular magnetic field sensor of the tool. In some aspects, window size may be a distance and in some aspects, window size can be a time duration. In the example of this sub-process, a time window with a duration (for example, as determined by the controller 999 based on feature size) is set for the first magnetic field sensor (for example, sensor 206) and all of the (multiple) magnetic field amplitude values sensed by the first magnetic field sensor within the time window (that starts at t₀) are recorded or identified by the controller 999.

The sub-process of FIG. 3B can continue at step 322, which includes determining a time window for the second magnetic field sensor of the same duration as the time window for the first magnetic field sensor. For example, the controller 999 sets the time window for the second magnetic field sensor with the same time duration as the time window for the first magnetic field sensor.

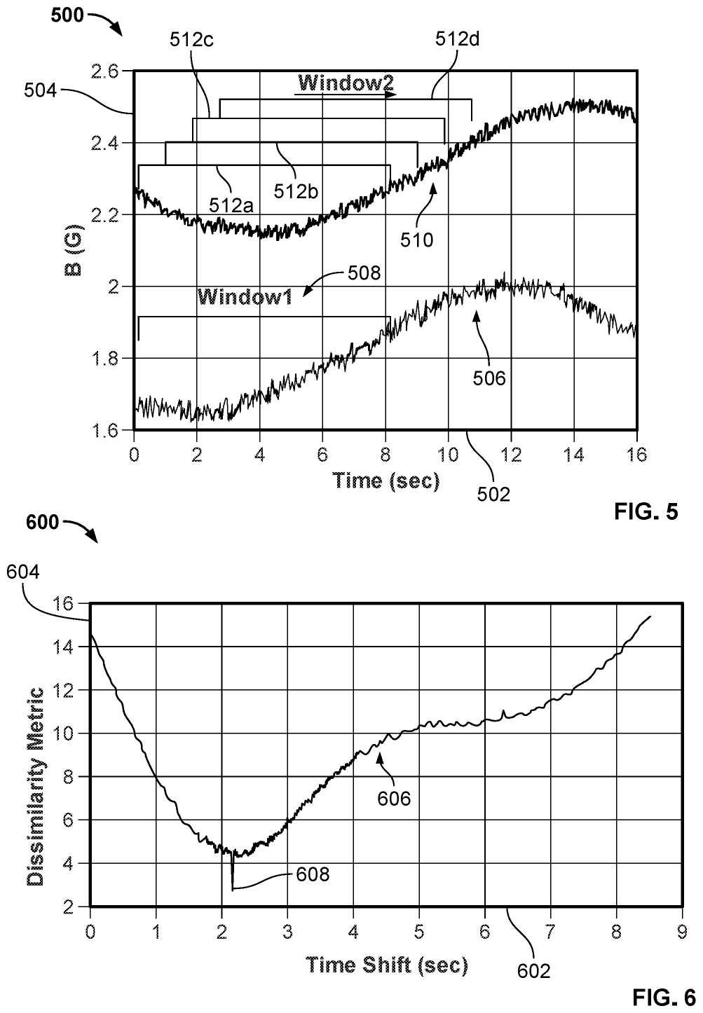

FIG. 5 shows a graph 500 that describes windowed magnetic field amplitude values over time for the first and second magnetic field sensors (for example, 206 and 204, respectively). Graph 500 includes an x-axis 502 of time (in seconds) and a y-axis 504 of magnetic field amplitude, B (in G). Curve 506 represents the magnetic field amplitude values sensed by the first magnetic field sensor (for example, sensor 206) within a time span that is longer than a selected window. Curve 510 represents the magnetic field amplitude values sensed by the second magnetic field sensor (for example, sensor 204) within a time span that is longer than a selected window. As shown in graph 500, time window 508 is the determined time window from step 320, in other words, the time window for the first magnetic field sensor. As shown, time window 508 is about 8 seconds long. Time window 512a is the determined time window set in step 322, in other words, the time window for the second magnetic field sensor. Consistent with time window 508, time window 512a is also about 8 seconds long.

In some aspects, a time span can be defined as a duration of time where at least a magnetic field feature, or pattern, can be identified and it can be longer than the length of a window. For example, in FIG. 5, the search span starts at 0^{th} second and extends to 16^{th} seconds, where typical window sizes were selected as 8 seconds long. The time span is also defined as where the feature is searched by shifting a window within this span. In some aspects, the time span can be limited within an expected value based on, for example, typical speeds of the downhole tool and the separation distance of the sensors in the tool. In an example aspect, the time span is long enough so that the measurements by the first and second sensors will have at least one overlapped feature. For example, in FIG. 5, the same feature is captured by the two sensors, and the time lag between the first and second sensors can be identified as around 2 seconds where the search span is selected as 16 seconds. In some examples, the length of the time span can be as long as the entire time of a logging job; however this increases the cost of the computation since an entire log is searched for each window.

The sub-process of FIG. 3B can continue at step 324, which includes determining a plurality of second magnetic field amplitudes sensed by the second magnetic field sensor in the time window for the second magnetic field sensor. For example, the controller 999 receives or identifies the multiple magnetic field amplitude values sensed by the second magnetic field sensor (for example, the values of curve 510) during the time window 512a.

The sub-process of FIG. 3B can continue at step 326, which includes processing the pluralities of first and second magnetic field amplitudes. For example, once the magnetic field amplitude values of the first and second magnetic field sensors in steps 322 and 324, respectively, are determined or identified, the controller 999 may perform one or more sub-steps of processing on such values. Processing can include subtracting the determined mean value of window 508 from each of the magnetic field amplitude values from the first magnetic field sensor and subtracting the determined mean value of window 512a from each of the magnetic field amplitude values from the second magnetic field sensor. In some aspects, the processing can include interpolation, downsampling, or upsampling. The processing can further include determining a mean magnetic field amplitude value for the values from the first magnetic field sensor in window 508 and subtracting the mean value from each value, so that the new mean value within the window becomes 0. The same processing can be applied to the values from the second magnetic field sensor in window 512a. Alternatively, or additionally, processing can subsequently also include normalizing the magnetic field amplitudes during the time window 508 from the first magnetic field sensor. Further processing can include normalizing the magnetic field amplitudes during the time window 512a from the second magnetic field sensor. The processed magnetic field amplitude values from step 326 can be used in subsequent steps in the sub-process (for example, rather than the unprocessed values).

In some aspects, normalizing (or normalization) includes dividing each measurement point in the window with the absolute maximum value within that window, so that the absolute maximum value within the window becomes 1, and absolute value of every other element becomes smaller than or equal to 1. In other words, in some aspects, all values are scaled by a constant to make them in the interval of [−1, 1]. In some aspects, the processing, such mean subtraction and normalizing can help to remove differences between two different sensors. For instance, a magnetic field at a location can be measured slightly differently by two different sensors and this can be due to slight difference in the placement of the sensors, calibration of the sensors, or any other inherent property of a particular sensor such as different magnetic field bias or sensitivity because of the fabrication tolerances.

The sub-process of FIG. 3B can continue at step 328, which includes determining an absolute value of each difference between corresponding first magnetic field amplitudes in the time window for the first magnetic field sensor and second magnetic field amplitudes in the time window of the second magnetic field sensor. For example, since the time windows 508 and 512a are equal (or substantially equal with a negligible difference), there can be an equal and corresponding number of amplitude values sensed by each of the first and second magnetic field sensors. Differences in value (absolute) of corresponding amplitude values can then be determined by the processor 999. As an example, an absolute value difference in value can be determined between the value on curve 506 at 1.1 seconds and the value on curve 510 at 1.1 seconds (and so on). In some aspects, processing steps such as interpolation, subsampling, or upsampling (or a combination thereof) can be used to make the number of samples equal in the two windows.

The sub-process of FIG. 3B can continue at step 330, which includes determining a sum of the absolute values to determine a metric of dissimilarity. For example, the controller 999 can sum the absolute values determined in step 328, with the sum representing a metric of dissimilarity between the sensed amplitude values of the first magnetic field sensor during time window 508 and the sensed amplitude values of the second magnetic field sensor during time window 512a.

The sub-process of FIG. 3B can continue at step 332, which includes a determination of whether a number of specified iterations of steps 322-330 are complete. For example, a preset or predetermined number of iterations of steps 322-330 can be programmed into the controller 999. In some aspects, the number of iterations may be several, 10s, 100s, or other number. A greater number of iterations can provide for a more accurate determination of a speed of the tool.

If the determination in step 332 is no, then the sub-process of FIG. 3B can continue at step 334, which includes shifting the time window for the second magnetic field sensor by a time shift to generate a next time window (for example, with a new start time) for the second magnetic field sensor. For example, as shown in FIG. 5, in a second iteration, the time shift for the second magnetic field sensor is from time window 512a to time window 512b (for example, about a 1 second shift). In a third iteration, the time shift for the second magnetic field sensor is from time window 512b to time window 512c (for example, another 1 second shift). In a fourth iteration, the time shift for the second magnetic field sensor is from time window 512c to time window 512d (for example, another 1 second shift), and so on. The sub-process continues from step 334 back to step 324, where the controller 999 receives or identifies the multiple magnetic field amplitude values sensed by the second magnetic field sensor (for example, the values of curve 510) during the next time window (for example, time window 512b for the second iteration, time window 512c for the third iteration, time window 512d for the fourth iteration, and so on). Thus, for each iteration (and each separate time window for the second magnetic field sensor), a separate metric of dissimilarity is determined in step 330.

If the determination in step 332 is yes, then the sub-process of FIG. 3B can continue at step 336, which includes determining a minimum metric of dissimilarity of the metrics of dissimilarity. For example, once the controller has determined a number of metrics of dissimilarity (equal to the number of iterations), a minimum or smallest value metric of dissimilarity is determined by the controller 999. For example, FIG. 6 shows a graph 600 that describes dissimilarity metrics as a function of time shift. Graph 600 includes an x-axis 602 of time shifts (in seconds) and a y-axis 604 of calculated metrics of dissimilarity (in arbitrary units). A curve 606 represents all of the metrics of dissimilarity determined in the iterations of step 330. Point 608 on curve 606 represents the minimum metric of dissimilarity.

As noted, the x-axis 602 is in time shifts, which can be a time difference between the start times of the first and second windows, namely how much the second window is shifted in time at a dissimilarity calculation step. Thus, as illustrated, the time metric of the x-axis in FIG. 6 is different than the time metric of the x-axis in FIG. 5.

The sub-process of FIG. 3B can continue at step 338, which includes identifying the time difference associated with the minimum metric of dissimilarity. For example, the controller 999 determines a particular time shift (and thus the corresponding time window for the second magnetic field sensor) in which the determined minimum metric of dissimilarity occurred. The minimum metric of dissimilarity may indicate the magnetic field features within the windows recorded by the first and second magnetic field sensors are very similar which further may indicate that the measurements from both sensors were recorded at the same location. Once the controller 999 determines the particular time shift, the second time instant, t₁, and the time difference, Δt=|t₁−t₀|, can be determined and the sub-process can return to method 300.

Method 300 may continue at step 310, which includes determining a speed of the tool moving in the magnetized tubular member based on a known separation distance and the identified time difference. For example, once the time difference in step 308 is determined, speed of the tool can be determined based on a ratio of separation distance (for example, between the first and second magnetic field sensors 206 and 204, respectively) and the determined time difference. For example, for the determined time difference, Δt, an average speed can be found as vₐᵥ=Δz/Δt.

Furthermore, a universal time stamp can be assigned to the calculated average speed (for example provided by a time that is kept by the controller 999 of the tool from the beginning of the job or a time that is synchronized to another reference time). For example, it can be the mean value of the times t₁ and t₀.

Method 300 may continue at step 312, which includes determining, based on the speed of the tool, a location of the tool within the magnetized tubular member. For example, based on a previous speed that has been determined, or a known instant in which the tool began to move through the steel tubular, a location or relative location of the tool in the steel tubular may be determined. For example, traveled distance since the last known reference point can be found by multiplying the calculated average speed by the elapsed time since when the tool was at the last known reference point until the time stamp of the calculated speed.

Method 300 may be recursively repeated to provide a continuous update of tool's speed and location during the job.

In some aspects, one or more steps of method 300 (or the sub-process shown in FIG. 3B) may be altered or modified for the tool 250 shown in FIG. 2C (for example, a tool with an array of magnetic field sensors, such as 20, rather than two magnetic field sensors). For example, FIG. 4H shows a graph 470 of a magnetic field amplitude curve 476 of a single magnetic field sensor (for example, a first or second magnetic field sensor of a two-sensor tool) with respect to time. As shown, graph 470 includes an x-axis 472 of time (in seconds) while y-axis 474 is of magnetic field amplitude, B (in G). FIG. 4I shows a graph 480 of the same magnetic field amplitude data (curve 476) with respect to depth (in other words, distance). Graph 480 includes an x-axis 482 of distance (in feet) while y-axis 484 is of magnetic field amplitude, B (in G). Circles 486 on FIG. 4I represent 20 discrete samples (from 20 magnetic field sensors in an array in the tool, with each sensor separated from adjacent sensor(s) by a known separation distance). Instead of scanning a single magnetic field sensor for about 30 seconds as in FIG. 4H, there can be 20 equally spaced magnetic field sensors that collect the same magnetic field amplitude values in an instant as in FIG. 4I (with an acquisition time of a magnetic field sensor sampling time which is 1-3 milliseconds and can effectively be ignored).

The scanning action of an array of magnetic field sensors results in scaling of the magnetic field amplitude values in time as a function of speed. As shown in FIGS. 4H-4I, the tool slowed down and paused around the 15 second mark during the tool movement. This produced a relatively constant magnetic field value reading in the time domain shown on curve 476 in FIG. 4H. When plotted against depth in FIG. 4I, this plateau disappeared, which should have been at around 0.9 ft. If there is such a drastic change in the speed, the scanned magnetic fields recorded by a two magnetic field sensor tool will be different. This can introduce errors to the speed measurement as the dissimilarity metric can take a large value at the corresponding depths. In the array acquisition method, the captured magnetic field will be indifferent to the speed of the tool. The results will only depend on the tool position. Therefore, errors due to drastic speed changes can be prevented.

Additionally, in some aspects, for a tool with an array of magnetic field sensors (such as tool 250), position, or displacement, of the tool can be determined directly without relying on the time reference. For a tool with two magnetic field sensors, displacement can be calculated first by determining the speed, and then by integrating the speed along time. Since the error in the speed measurement accumulates, after some time, the position measurement can be off when determining speed with a two-sensor tool. Directly measuring the position can prevent this error.

Considerations for a tool with an array of magnetic field sensors (such as tool 250) can be a number of the sensors and separation distance between the sensors. The separation distance between magnetic field sensors, in some aspects, can be selected smaller than the feature size in order to resolve them. For example, employing the Nyquist theorem, twice the sampling rate of the highest frequency content that should be resolved may be required. For example, as described, there may be features up to 1 ft⁻¹ frequency. Therefore, in an array, magnetic field sensors can be placed with a rate of 2 ft⁻¹, which corresponds to a minimum of 0.5 ft. separation distance. In order to increase the accuracy of the amplitude measurement and displacement detection, the separation can be less (e.g., 0.1 ft.). The total length of the magnetic field sensor array with the determined separation distance can cover a distance that is enough to capture at least one feature at a time (e.g., 1-2 ft.). The discrete data then can be interpolated, for example using a cubic spline function before applying method 300.

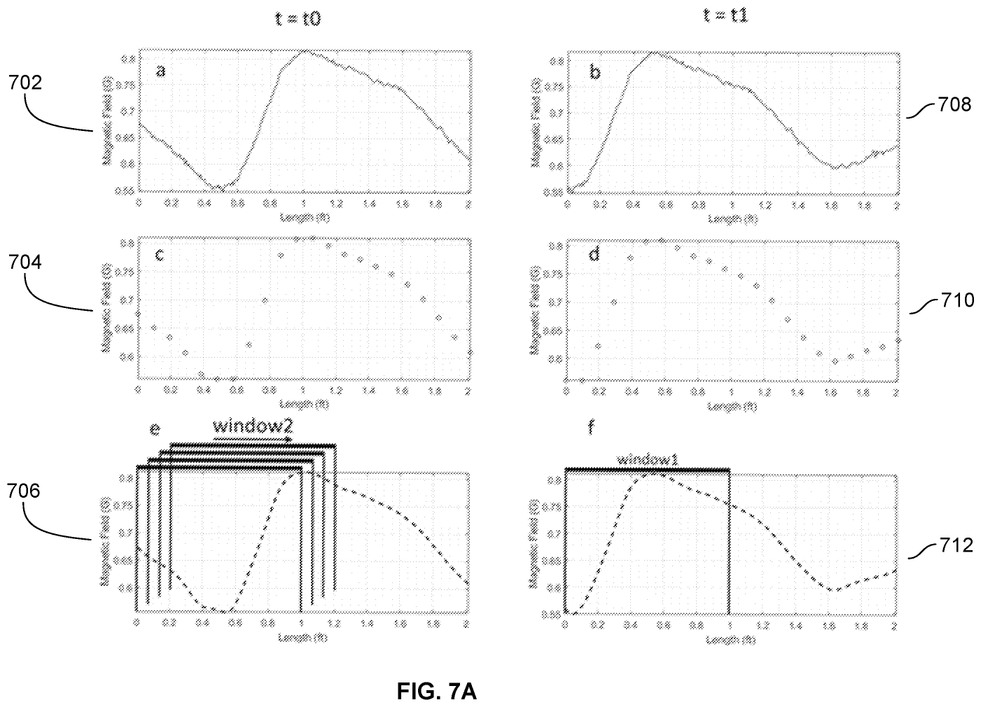

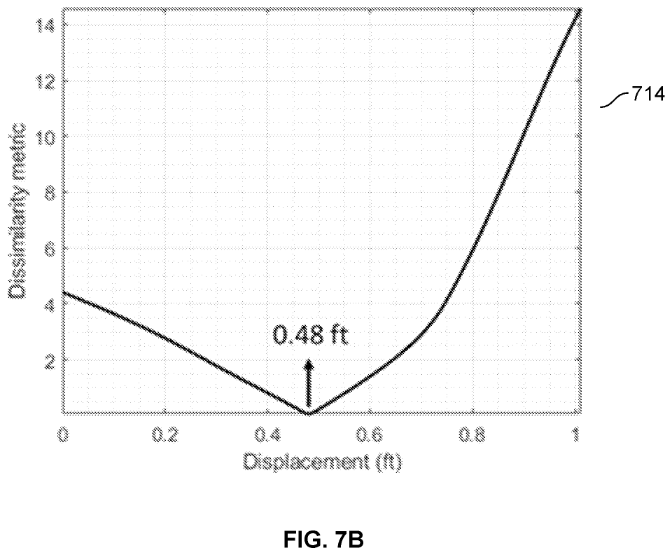

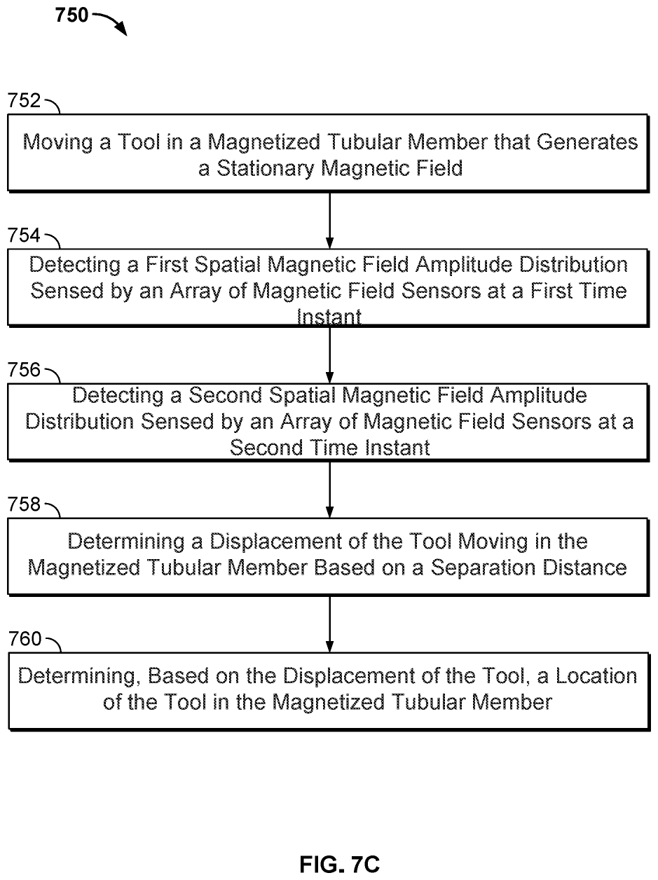

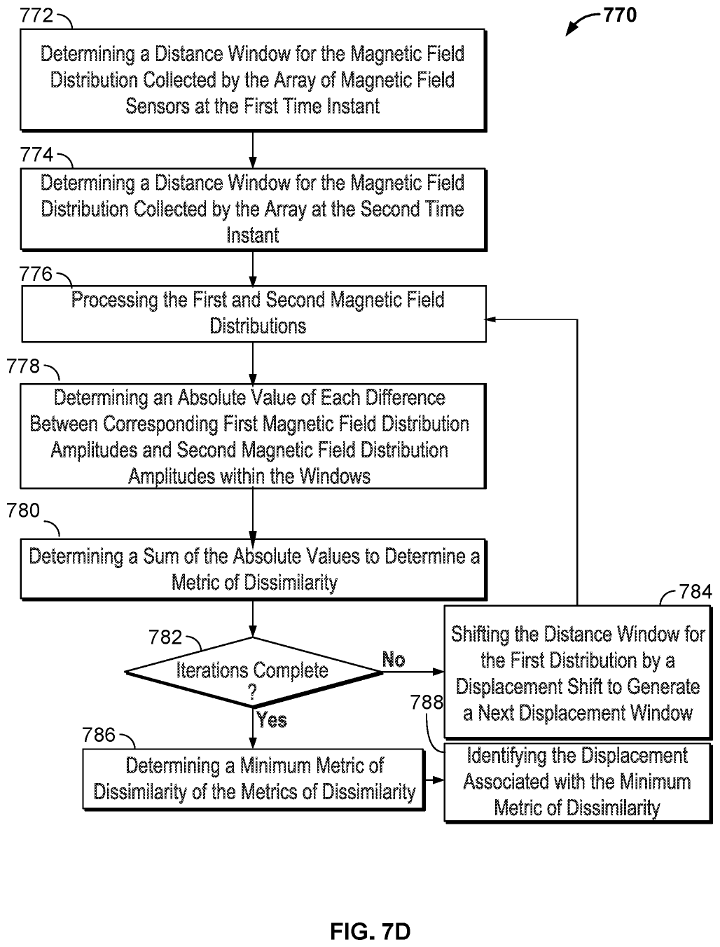

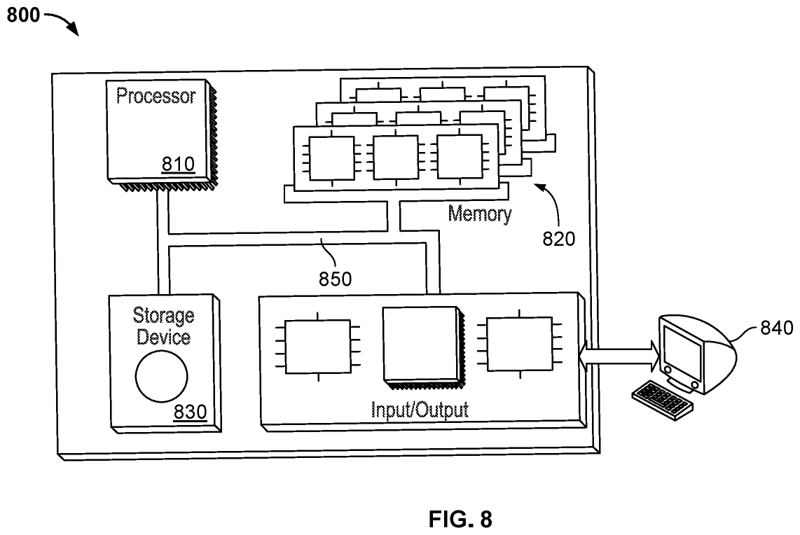

In another example implementation, similar to the downhole tool shown in FIG. 2C, a downhole tool can have 20 magnetic field sensors. For example, FIGS. 7A-7B illustrate graphs associated with such a downhole tool. More specifically, graphs 702 and 708 show magnetic field amplitudes in a tubular corresponding to the tool's position at the times to and t₁. Using a magnetic sensor array that is composed of 20 sensors distanced by 0.1 ft. from each other, the tool captures a discrete magnetic field distribution as shown in graphs 704 and 710 at these time instants. By running an interpolation (such as a cubic spline), semi-continuous (for example, less discrete) magnetic fields can be restored as shown in graphs 706 and 712. Using the interpolated data, a feature can be windowed at the beginning of the time instant, t₁, and search this feature within the magnetic field distribution collected previously at the time, to. The operation is, similarly, defining a window of the same size, that starts at the beginning of the data at the time to, calculating point-wise differences, summing, and taking the absolute value to find a dissimilarity metric. The window can be iteratively shifted by a small amount (such as 0.01 feet) to find a minimum of the dissimilarity metric. The example result is shown in graph 714 of FIG. 7B, where a minimum is found when the window is shifted for ˜0.48 ft. This result can indicate the amount of displacement directly that happened between the times to and t₁. The location of the tool can be tracked by adding the displacements together with respect to a previously known reference depth or length such as the surface, or a casing joint that is detected using a casing collar locator. If desired, an average speed can be calculated by dividing this distance by the absolute value of the difference between t₁ and to (however, speed calculation is not necessary to find the displacement and location.)

FIGS. 7C-7D are flowcharts that illustrate example processes for determining a speed, location, or both, of a tool in a tubular according to the present disclosure. For example, FIG. 7C illustrates method 750 for determining a location of a tool in a tubular. In some aspects, method 750 may be performed with or by a tool with multiple (such as 20) magnetic field sensors and, more specifically, a controller of the tool, either during a downhole operation of the tool or at the surface. Method 750 may begin at step 752, which includes moving a tool in a magnetized tubular member that generates a stationary magnetic field. For example, the tool may be moved through a steel wellbore tubular or through a steel pipeline. As described, the steel tubular may generate or include a stationary magnetic field due to the manufacturing process.

Method 750 may continue at step 754, which includes detecting a first spatial magnetic field amplitude distribution sensed by an array of magnetic field sensors at a first time instant. For example, as described with reference to FIGS. 7A-7B, a tool with, for example, 20 sensors distanced by 0.1 ft. from each other, can capture a discrete magnetic field distribution at time instant, to.

Method 750 may continue at step 756, which includes detecting a second spatial magnetic field amplitude distribution sensed by the array of magnetic field sensors at a second time instant. For example, as described with reference to FIGS. 7A-7B, the tool with 20 sensors distanced by 0.1 ft. from each other can capture a discrete magnetic field distribution at time instant, t₁.

Method 750 may continue at step 758, which includes determining a displacement of the tool moving in the magnetized tubular member based on a separation distance. For example, a minimum dissimilarity metric is found when the window is shifted for a particular distance. This result can indicate the amount of displacement directly that happened between the times to and t₁.

Step 758 can be implemented by sub-process 770, which is shown in FIG. 7D. For example, sub-process 770 can begin at step 772, which includes determining a distance window for the magnetic field distribution collected by the array of magnetic field sensors at the first time instant (t₀). The sub-process of FIG. 7D can continue at step 774, which includes determining a distance window for the magnetic field distribution collected by the array of magnetic field sensors at the second time instant (t₁).

The sub-process of FIG. 7D can continue at step 776, which includes processing the first and second magnetic field distributions. Processing can include subtracting the determined mean value of a window from each of the magnetic field amplitude values in the window. In some aspects, the processing can subsequently also include normalizing each of the magnetic field amplitudes during the distance windows.

The sub-process of FIG. 7D can continue at step 778, which includes determining an absolute value of each difference between corresponding first magnetic field distribution amplitudes and second magnetic field distribution amplitudes within the windows. For example, since the distance windows are equal in length (or substantially equal with a negligible difference), there can be an equal and corresponding number of distribution amplitude values sensed by the array of magnetic field sensors from which absolute values can be determined.

The sub-process of FIG. 7D can continue at step 780, which includes determining a sum of the absolute values to determine a metric of dissimilarity. For example, the controller can sum the absolute values of magnetic field distribution amplitudes determined in step 778, with the sum representing a metric of dissimilarity between the sensed distribution amplitude values of the array during a first distance window and the sensed distribution amplitude values of the array during the second distance window.

The sub-process of FIG. 7D can continue at step 782, which includes a determination of whether a number of specified iterations of steps 772-780 are complete. For example, a preset or predetermined number of iterations of steps 772-780 can be programmed into the controller. In some aspects, the number of iterations may be several, 10s, 100s, or other number. A greater number of iterations can provide for a more accurate determination of a speed of the tool.

If the determination in step 782 is no, then the sub-process of FIG. 7D can continue at step 784, which includes shifting the distance window for the first distribution by a displacement shift to generate a next distance window. For example, the distance window can be iteratively shifted by a small amount (such as 0.01 feet) to find a minimum of the dissimilarity metric. The sub-process continues from step 784 back to step 776. Thus, for each iteration (and each separate distance window), a separate metric of dissimilarity is determined in step 780.

If the determination in step 782 is yes, then the sub-process of FIG. 7D can continue at step 786, which includes determining a minimum metric of dissimilarity of the metrics of dissimilarity. For example, a number of metrics of dissimilarity (equal to the number of iterations) has been determined, a minimum or smallest value metric of dissimilarity is determined.

The sub-process of FIG. 7D can continue at step 788, which includes identifying the displacement associated with the minimum metric of dissimilarity. For example, the controller can determine a particular distance window in which the determined minimum metric of dissimilarity occurred. The sub-process can return to method 750.

Method 750 may continue at step 760, which includes determining a location of the tool moving in the magnetized tubular member based on the displacement of the tool. For example, the location of the tool can be tracked by adding the displacements together with respect to a previously known reference depth or length such as the surface, or a casing joint that is detected using a casing collar locator. Also, an average speed can be calculated by dividing this distance by the absolute value of the difference between t₁ and to (however, speed calculation is not necessary to find the displacement and location.)

Method 750 may be recursively repeated to provide a continuous update of tool's location during the job.

FIG. 8 is a schematic illustration of an example controller 800 (or control system) for determining a location, speed, or both, of a tool in a tubular. For example, all or parts of the controller 800 can be used for the operations described previously, for example as or as part of the controller 999. The controller 800 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output device 840. Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the controller 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, a tape device, flash memory, a solid state device (SSD), or a combination thereof.

The input/output device 840 provides input/output operations for the controller 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A measurement tool system, comprising:
a tool, comprising:
a housing configured to fit within and run into a magnetized tubular member, the housing defining an interior volume;
a first magnetic field sensor positioned on or within the housing at a first location; and
a second magnetic field sensor positioned on or within the housing at a second location apart from the first location by a separation distance, each of the first and second magnetic field sensors configured to detect a magnetic field amplitude value of a stationary magnetic field generated by the magnetized tubular member; and
a controller configured to perform operations comprising:
identifying a first magnetic field amplitude distribution sensed by the first magnetic field sensor started at a first time instant;
identifying a second magnetic field amplitude distribution sensed by the second magnetic field sensor started at a second time instant;
determining a time difference between the first and second time instants based on the identified first and second magnetic field amplitudes; and
determining a speed of the housing based on the separation distance and the time difference.

2. The measurement tool system of claim 1, wherein at least one of the first or second magnetic field sensors comprises a magnetoresistance or hall-effect sensor.

3. The measurement tool system of claim 1, wherein the magnetized tubular member comprises a wellbore casing or a hydrocarbon system pipeline.

4. The measurement tool system of claim 1, wherein the controller is configured to perform operations further comprising determining, based on the speed of the housing, a location of the housing within the magnetized tubular member.

5. The measurement tool system of claim 4, wherein determining, based on the speed of the housing, a location of the housing within the magnetized tubular member comprises:
determining a displacement of the housing by integrating the speed over the time difference; and
determining the location based on the determined displacement and a known location of the housing at the first time instant.

6. The measurement tool system of claim 1, wherein the separation distance is based on a reference distance for a change to the magnetic field amplitude value of the stationary magnetic field at least above a noise level of the stationary magnetic field.

7. The measurement tool system of claim 6, wherein the separation distance is less than or equal to the reference distance.

8. The measurement tool system of claim 6, wherein the separation distance is greater than the reference distance.

9. The measurement tool system of claim 1, wherein determining the time difference between the first and second time instants based on the identified first and second magnetic field amplitudes comprises:
(i) determining a time window for the first magnetic field sensor that begins at the first time instant, the time window comprising a plurality of first magnetic field amplitudes sensed by the first magnetic field sensor;
(ii) determining a first time window for the second magnetic field sensor of the same duration as the time window for the first magnetic field sensor, the first time window comprising a plurality of second magnetic field amplitudes sensed by the second magnetic field sensor;
(iii) determining an absolute value of each difference between corresponding first magnetic field amplitudes in the time window for the first magnetic field sensor and second magnetic field amplitudes in the first time window of the second magnetic field sensor;
(iv) determining a sum of the absolute values to determine a metric of dissimilarity;
(v) shifting the first time window for the second magnetic field sensor by a time shift to generate a next time window for the second magnetic field sensor;
(vi) based on the shifting, iterating operations (iii)-(v) for a specified number of iterations to determine a plurality of metrics of dissimilarity;
(vii) determining a minimum metric of dissimilarity of the plurality of metrics of dissimilarity; and
(viii) identifying a time instant associated with the minimum metric of dissimilarity, the identified time instant comprising the second time instant.

10. The measurement tool system of claim 9, wherein the time window is based on an expected speed of the housing and the separation distance.

11. The measurement tool system of claim 9, wherein the controller is configured to perform operations further comprising:
processing the plurality of first magnetic field amplitudes sensed by the first magnetic field sensor in the time window between (i) and (iii); and
processing the plurality of second magnetic field amplitudes sensed by the second magnetic field sensor in the first time window between (ii) and (iii).

12. The measurement tool system of claim 11, wherein the processing comprises at least one of:
subtracting a mean value of the plurality of first magnetic field amplitudes from each of the plurality of first magnetic field amplitudes, and subtracting a mean value of the plurality of second magnetic field amplitudes from each of the plurality of second magnetic field amplitudes; or
normalizing the plurality of first magnetic field amplitudes and the plurality of second magnetic field amplitudes.

13. A method for operating a tool, the method comprising:
moving a tool in a magnetized tubular member that generates a stationary magnetic field, the tool comprising a housing that defines an interior volume, a first magnetic field sensor positioned on or within the housing at a first location, and a second magnetic field sensor positioned on or within the housing at a second location apart from the first location by a separation distance;
detecting a first magnetic field amplitude distribution sensed by the first magnetic field sensor started at a first time instant;
detecting a second magnetic field amplitude distribution sensed by the second magnetic field sensor started at a second time instant;
determining a time difference between the first and second time instants based on the identified first and second magnetic field amplitudes; and
determining a speed of the tool moving in the magnetized tubular member based on the separation distance and the time difference.

14. The method of claim 13, wherein at least one of the first or second magnetic field sensors comprises a magnetoresistance or hall-effect sensor.

15. The method of claim 13, wherein the magnetized tubular member comprises a wellbore casing or a hydrocarbon system pipeline.

16. The method of claim 13, further comprising determining, based on the speed of the tool, a location of the tool within the magnetized tubular member.

17. The method of claim 16, wherein determining, based on the speed of the tool, a location of the tool within the magnetized tubular member comprises:
determining a displacement of the tool by integrating the speed over the time difference; and
determining the location based on the determined displacement and a known location of the tool at the first time instant.

18. The method of claim 13, wherein the separation distance is based on a reference distance for a change to the magnetic field amplitude value of the stationary magnetic field at least above a noise level of the stationary magnetic field.

19. The method of claim 18, wherein the separation distance is less than or equal to the reference distance.

20. The method of claim 18, wherein the separation distance is greater than the reference distance.

21. The method of claim 13, wherein determining the time difference between the first and second time instants based on the identified first and second magnetic field amplitudes comprises:
(i) determining a time window for the first magnetic field sensor that begins at the first time instant, the time window comprising a plurality of first magnetic field amplitudes sensed by the first magnetic field sensor;
(ii) determining a first time window for the second magnetic field sensor of the same duration as the time window for the first magnetic field sensor, the first time window comprising a plurality of second magnetic field amplitudes sensed by the second magnetic field sensor;
(iii) determining an absolute value of each difference between corresponding first magnetic field amplitudes in the time window for the first magnetic field sensor and second magnetic field amplitudes in the first time window of the second magnetic field sensor;
(iv) determining a sum of the absolute values to determine a metric of dissimilarity;
(v) shifting the first time window for the second magnetic field sensor by a time shift to generate a next time window for the second magnetic field sensor;
(vi) based on the shifting, iterating operations (iii)-(v) for a specified number of iterations to determine a plurality of metrics of dissimilarity;
(vii) determining a minimum metric of dissimilarity of the plurality of metrics of dissimilarity; and
(viii) identifying a time instant associated with the minimum metric of dissimilarity, the identified time instant comprising the second time instant.

22. The method of claim 21, wherein the time window is based on an expected speed of the tool and the separation distance.

23. The method of claim 21, further comprising:
processing the plurality of first magnetic field amplitudes sensed by the first magnetic field sensor in the time window between (i) and (iii); and
processing the plurality of second magnetic field amplitudes sensed by the second magnetic field sensor in the first time window between (ii) and (iii).

24. The method of claim 23, wherein the processing comprises at least one of:
subtracting a mean value of the plurality of first magnetic field amplitudes from each of the plurality of first magnetic field amplitudes, and subtracting a mean value of the plurality of second magnetic field amplitudes from each of the plurality of second magnetic field amplitudes; or
normalizing the plurality of first magnetic field amplitudes and the plurality of second magnetic field amplitudes.

25. A measurement tool, comprising:
a housing configured to fit within and run into a magnetized tubular member, the housing defining an interior volume;
a plurality of magnetic field sensors positioned on or within the housing, each of the plurality of magnetic field sensors configured to detect a magnetic field amplitude value of a stationary magnetic field generated by the magnetized tubular member, each pair of adjacent magnetic field sensors separated by a preset separation distance;
a controller positioned in the interior volume or on the housing and configured to perform operations comprising:
identifying a plurality of first magnetic field amplitudes sensed by the plurality of magnetic field sensors at a first time instant;
identifying a plurality of second magnetic field amplitudes sensed by the plurality of magnetic field sensors at a second time instant subsequent to the first time instant;
correlating the plurality of second magnetic field amplitudes sensed by the plurality of magnetic field sensors at the second time instant with the plurality of first magnetic field amplitudes sensed by the plurality of magnetic field sensors at the first time instant; and
determining, based on the correlation, a distance between the housing at a first location in the magnetized tubular member at the first time instant and the housing at a second location in the magnetized tubular member at the second time instant.

26. The measurement tool of claim 25, wherein the controller is configured to perform operations further comprising determining a speed of the housing based on the distance and a difference between the second time instant and the first time instant.

27. The measurement tool of claim 25, wherein the plurality of magnetic field sensors comprises at least ten magnetic field sensors.

28. The measurement tool of claim 25, wherein identifying the first plurality of magnetic field amplitudes sensed by the plurality of magnetic field sensors at the first time instant comprises:
identifying one of the first plurality of magnetic field amplitudes that is sensed for each of the plurality of magnetic field sensors at the first time instant.

29. The measurement tool of claim 25, wherein the magnetized tubular member comprises a wellbore casing or a hydrocarbon system pipeline.

30. The measurement tool of claim 25, wherein correlating the plurality of second magnetic field amplitudes sensed by the plurality of magnetic field sensors at the second time instant with the plurality of first magnetic field amplitudes sensed by the plurality of magnetic field sensors at the first time instant comprises:
(i) determining, for each of the plurality of magnetic field sensors, an absolute value of a difference between the second magnetic field amplitude and the first magnetic field amplitude; and
(ii) determining a sum of the absolute values to determine a metric of dissimilarity.

31. The measurement tool of claim 30, wherein the controller is configured to perform operations further comprising:
(iii) identifying a plurality of next magnetic field amplitudes sensed by the plurality of magnetic field sensors at a next time instant subsequent to the second time instant;
(iv) determining, for each of the plurality of magnetic field sensors, a next absolute value of a difference between the next magnetic field amplitude and the first magnetic field amplitude; and
(v) determining a next sum of the next absolute values to determine a next metric of dissimilarity.

32. The measurement tool of claim 31, wherein the controller is configured to perform operations further comprising:
(vi) iterating operations (iii)-(v) for a specified number of iterations to determine a plurality of metrics of dissimilarity;
(vii) determining a minimum metric of dissimilarity of the plurality of metrics of dissimilarity;
(viii) identifying a distance associated with the minimum metric of dissimilarity; and
(ix) determining a new location of the housing at the next time instant based on the identified distance associated with the minimum metric of dissimilarity and previously known location at the first time instant

33. The measurement tool of claim 32, wherein the controller is configured to perform operations further comprising determining speed of the housing based on the identified distance associated with the minimum metric of dissimilarity and a difference between the next time instant and the first time instant.
